(19) United States
(12) Patent Application Publication
(10) Pub. No.: US 2022/0101127 A1
(43) Pub. Date: Mar. 31, 2022

(54) AUTOMATIC OPTIMIZATION OF MACHINE LEARNING ALGORITHMS IN THE PRESENCE OF TARGET DATASETS

(71) Applicant: Urugus S.A., Montevideo (UY)

(72) Inventors: Albert Pujol Torras, Barcelona (ES); Pau de Jorge Aranda, Barcelona (ES); Francisco Javier Marin Tur, Barcelona (ES); Marc Romani, Barcelona (ES)

(21) Appl. No.: 17/428,395

(22) PCT Filed: Feb. 5, 2020
(86) PCT No.: PCT/US20/16760

§ 371 Date: Aug. 4, 2021

Related U.S. Application Data
(60) Provisional application No. 62/801,534, filed on Feb. 5, 2019.

(51) Int. Cl. G06N 3/08; G06K 9/62

(52) U.S. Cl. CPC G06N 3/08; G06K 9/6261; G06K 9/6256; G06K 9/6215

(57) ABSTRACT

Methods, systems and computer program products for transferring knowledge using machine learning techniques by automatically generating training datasets are provided. New training datasets based on target datasets are automatically generated and used in machine learning techniques to perform tasks on images. One of the main benefits is the possibility to transfer the knowledge learned in one domain to another domain in which extracting data or labeling images would be costly or simply infeasible. The methods and systems also provide image training sets based on image target sets which augments data in a more efficient way and improves the content of the training set and the prediction of the machine learning techniques.

### CROSS REFERENCE TO RELATED APPLICATIONS

The present application claims priority to U.S. Provisional Application No. 62/801,534, filed on Feb. 5, 2019, entitled “AUTOMATIC OPTIMIZATION OF MACHINE LEARNING ALGORITHMS IN THE PRESENCE OF TARGET DATASETS,” the entire contents of which are incorporated herein in its entirety by reference.

### BACKGROUND

Machine learning techniques allow us to train models to learn specific tasks. In order to train such models, a training dataset with the corresponding ground truth is required. The common approach to train machine learning algorithms in a given domain is to train a global model using all the samples from a given training dataset, where the ground truth is usually manually created or annotated. When the tasks relate to images, the output obtained by these models upon new unseen target images works best when used with images similar to the training set, and shows a significant performance drop when applied to different and diverse images, that can be largely dissimilar from the images of the training sets. An advantage would be to have more images in the training sets so that the probability of having more similar images increases. However, in spite of the increasing amount of images constantly generated by an image acquisition system, it is difficult or even impossible to manually annotate or identify image content labels or extract image data contained in the huge number of images. Prior-art attempts to automatically label or extract image data have shown a poor performance with high prediction errors. Consequently, there is a need to develop novel and effective tools to automatically train machine learning algorithms to perform different types of tasks on images.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a flowchart diagram of an example method to generate a semantic segmentation of images based on different land use classes according to embodiments of the present disclosure.

FIG. 2 is flowchart diagram of exemplary method to generate a training set based on target datasets having labeled training datasets similar to the target datasets according to embodiments of the present disclosure.

FIG. 3 illustrates an exemplary method of using a generated training set comprising labeled training datasets similar to the target datasets according to embodiments of the present disclosure.

FIG. 4 shows another flowchart diagram of an exemplary method to generate a training set based on target datasets having chunks of target images predicted with high confidence according to embodiments of the present disclosure.

FIG. 5 illustrates an exemplary method of generating and using a generated training set based on target datasets comprising labeled training datasets similar to the target datasets and chunks of target images predicted with high confidence according to embodiments of the present disclosure.

FIG. 6 illustrates a satellite-based imaging system having an optics/capturing system and a control module which generates a training set and trains a machine learning algorithm to automatically identify and classify the type of land contained in the image according to embodiments of the present disclosure.

FIG. 7 illustrates an UAV system having a camera and a control module configured to generate a training set and train a machine learning algorithm to automatically extract data from aerial images according to embodiments of the present disclosure.

Elements in the figures are illustrated for simplicity and clarity and have not been drawn to scale. Also, certain actions and/or steps may be described or depicted in a particular order while those skilled in the art will understand that such specificity with respect to sequence is not actually required.

### DETAILED DESCRIPTION

### Overview

Embodiments according to the present disclosure include methods, systems and computer program products for transferring knowledge using machine learning techniques with automatically generated training datasets. Embodiments also include automatically generating training datasets from target datasets for machine learning to perform tasks on images. One of the main benefits is the possibility to transfer the knowledge learned in one domain to another domain in which extracting data or labeling images would be costly or simply infeasible. Similarly, another benefit is to transfer the knowledge learned in one domain to a sub-domain, achieving improved performance. The methods and systems according to the present disclosure also provide training sets based on the target set which augments data in a more efficient way and improves the content of the training set.

Prior art machine learning techniques are usually trained to generate outputs for the whole domain defined by the labeled training dataset (first training dataset). However, the models learned with a global training dataset might perform sub-optimally/poorly when facing a target dataset which belongs to a new domain or sub-domain that differs from the original training dataset (first training dataset), even if the original labeled training dataset have samples similar to the target ones, due to the fact that the learning algorithm optimizes a function in the whole labeled training dataset domain. To overcome this drawback, embodiments described herein provide methods (computer-implemented methods) to train a mathematical model to optimize a unique function in the whole dataset domain, and to further re-train the mathematical model around the target domain with an automatically generated training dataset (second training dataset), so that the function is locally adjusted to the target dataset. In some instances, the mathematical model is already trained in the whole dataset domain, and the method provided herein re-trains the mathematical model around the target domain with an automatically generated training dataset (second training dataset), so that the function is locally adjusted to the target dataset.

The training dataset comprises images that belong to different classes. In some embodiments, the training dataset contains images in classes that are the same as those to be predicted in the target dataset, so the model may be trained in those classes. In some cases, the images of the training dataset comprise images with proportionally the same representation of classes, whereas in other cases the training dataset comprises images with the same representation of classes but in a different proportion. If necessary, several methods may be applied to correct the imbalance of the training dataset, when the training dataset has classes represented by a few instances while other classes have a large number of representative instances.

Embodiments according to the present disclosure also include training mathematical predictive models such as, but not limited to, regression, classification, segmentation and/or clustering models. Depending on the nature of the image content, the output predicted by the model may comprise continuous or discrete values. In some cases, the model is used to automatically predict discrete image content labels, for example, when the model automatically assigns a semantic label to different elements or characteristics contained within an image. In other cases, the model is used to automatically predict continuous values, for example by determining quantities based on the elements or characteristics contained within an image.

The present disclosure provides a method (a computer-implemented method) to automatically transfer knowledge in machine learning algorithms (to automatically generate training datasets in machine learning algorithms), the method comprising: training a mathematical model with images of a first training dataset to reduce a global error measured across all the training dataset's domain to obtain a global domain mathematical model; obtaining at least one target dataset, wherein the at least one target dataset comprises at least one image; generating a second training dataset based on the at least one image; and retraining the global domain mathematical model with said second training dataset; wherein training the mathematical model comprises executing a machine learning algorithm. The present disclosure thus provides a computer-implemented method to automatically transfer knowledge in machine learning algorithms, comprising training a mathematical model to reduce some global error measured across all a source domain defined by a preselected training dataset. After training the mathematical model in the whole training set domain, a global mathematical model or global domain mathematical model (these two expressions are to be considered equivalent in the present disclosure) is obtained. When the global mathematical model is used to predict an output value for a target dataset having a target domain which is a new or different domain or a subdomain of the source domain, it can happen that the target dataset belongs to a target domain where the error of the trained global mathematical model is high. For this reason, after obtaining at least one target dataset, the method further comprises generating a second training dataset to retrain the global domain mathematical model in a neighborhood of the target dataset, so that it can locally achieve a higher performance. In general, the step of training or retraining a mathematical model comprises executing a machine learning algorithm or adjusting the parameters of the mathematical model executing a machine learning algorithm, for example support vector machine, random forest, and neural networks, such as convolutional neural networks, fully convolutional neural networks, non-convolutional neural networks, among others.

In some embodiments, the second training dataset comprises, but is not limited to, images from the first training dataset that are similar to the at least one image from the at least one target dataset. In other embodiments, the second training dataset includes portions or full images from the at least one target dataset that were predicted by the global mathematical model with high confidence. In still other embodiments, the second training dataset includes a set of images comprising images that are similar to the target dataset, and portions or full images from the at least one target dataset that were predicted by the global mathematical model with high confidence. Additionally or alternatively, in still other embodiments, the second training dataset further includes manually annotated/labeled full images or portions of images of the target dataset that were classified by the global mathematical model with low confidence and/or that were not similar to the original training set (i.e.: the first training dataset).

One approach to generate a second training dataset having images from the first training dataset that are similar to the images from the (at least one) target dataset includes measuring the similarity between images, for example measuring the similarity between pixel level or image level descriptors. In some embodiments, the similar images are selected using image feature descriptor vectors totally or partially derived from a pre-trained machine learning model. For example, image feature descriptors derived from pre-trained models may be the numeric response of any of the layers before the last layer. The neural network is dissected and the values yield at any of the hidden layers before the output layer may be taken as descriptors. Additionally or alternatively, in some embodiments, the similar images are selected by measuring the similarity between pixel level or image level descriptors of the images from the first training dataset and the at least one image from the at least one target dataset. In some embodiments, the method further comprises generating an image feature descriptor vector for each pixel or set of pixels of each image from the target dataset, and also for each pixel or set of pixels of each image from the training dataset, then computing the distance between image feature descriptor vectors, and selecting only those pixels/sets of pixels from the images of the first training dataset that are close in distance to the pixels/sets of pixels of the images of the target dataset. Close in distance can be interpreted as having a distance value which is lower than a certain distance threshold. Those pixels/sets of pixels from the images of the first training dataset that are close in distance to the pixels/sets of pixels of the images of the target dataset are therefore considered similar. In some embodiments, the image feature descriptor vector is the result of combining different image feature descriptor vectors selected from a group comprising, for example, but not limited to, histograms of gradient orientations (HOG), red-green-blue (RGB) color histograms, texture histograms, response to wavelets filters, artificial neural networks, and deep neural network features extracted from a pre-trained model. For example, a convolutional neural network may be used as feature extractor, and/or image feature descriptors may be derived from pre-trained models wherein any value yield from any of the hidden layers before the output layer may be chosen as feature descriptors.

In some embodiments the image feature descriptor vectors, the way image feature descriptor vectors are combined, into a single vector by concatenating them or applying any type of function that yields a new feature descriptor, and the function that measures the distance (e.g. Euclidean distance, cosine similarity, Chebyshev distance, etc.) between them are selected depending on which image transformation invariances are desired, that is, depending on which image transformation invariances are to be used. Image transformation invariances include but are not limited to any combination of translations, rotations, scaling, shear, image blur, and image bright and contrast changes.

In other embodiments, after generating image feature descriptor vectors and computing the distance between them, the method further comprises selecting those pixels/sets of pixels from the images of the target dataset that are far in distance to the pixels/sets of pixels of the images of the training dataset, manually annotating a label or assigning a value, and adding the labeled or manually annotated target images to the second training set, to include the minimum number of images to be annotated that covers the zones undefined by the original dataset (the first training dataset). Far in distance can be interpreted as having a distance value which is equal to or larger than a certain threshold. Pixels/sets of pixels of the images of the target dataset that are far in distance to the pixels/sets of pixels of the images of the training dataset are therefore considered dissimilar images.

One approach to generate a second training dataset having one or more chunks/portions of or full images from the images of the target dataset is to test the images from the target dataset with the global mathematical model, which has been first trained in the whole training set domain and selecting those full or portions of images from the target dataset whose output values were predicted by the global mathematical model with high confidence.

For example, in some embodiments, the chunks (portions) of one or more target images may be obtained by using a semi-supervised machine learning method. In some instances, the chunks of one or more target images are selected using their pixel-wise confidence levels, wherein a threshold value per class is preselected and the prediction from mathematical model in all the pixels is over said preselected threshold. The semi-supervised machine learning method may be for example a network for semantic segmentation that only gets to know the labels present in the image, but not actually information about each pixel value. The portions of the target images are based on the confidence/probability that the global mathematical model trained with the source/original dataset (the first training dataset) has. A portion may be a part of the image where all the pixels within it were classified with a high probability i.e. a probability above a predetermined threshold. Depending on the portion, we may have not just one class but multiple ones. For instance, a target image may be an image depicting a forest and a city, with a river in the middle separating them. The mathematical model may have a high confidence classifying the river and the forest, but a low confidence classifying the city side, or may even classify some areas of the city incorrectly. The portion to be used in this case is the portion of the image containing only the river and the forest.

In other embodiments, the full target images or portions of target images whose output values were predicted by the global mathematical model with low confidence, are selected to manually annotate a label or assign a value, and are added to the second training set.

In some embodiments, the at least one target dataset is captured by an imaging device all or partially onboard an aerial vehicle, wherein the aerial vehicle can be selected from a group comprising, but not limited to, a satellite, a spacecraft, an aircraft, a plane, an unmanned aerial vehicle (UAV), and a drone.

Embodiments include a system comprising an imaging device, a global domain mathematical model, and a control module. The imaging device is configured to capture at least one target image. The global domain mathematical model may be trained with a first training dataset to reduce a global error measured across all the first training dataset's domain. The control module is configured to obtain at least one target dataset, wherein the at least one target dataset comprises the at least one target image; generate a second training dataset based on the at least one target image; and retrain the global domain mathematical model with the second training dataset; wherein training the mathematical model comprises executing a machine learning algorithm. In some embodiments, the control module is configured to train a mathematical model with a first training dataset to reduce a global error measured across all the first training dataset's domain to obtain a global domain mathematical model; obtain at least one target dataset, wherein the at least one target dataset comprises the at least one target image; generate a second training dataset based on the at least one target image; and retrain the global domain mathematical model with the second training dataset; wherein training the mathematical model comprises executing a machine learning algorithm.

The imaging device is thus configured to capture volatile or fixed images comprising the target images. The target images have image content characteristics which at the moment of the capture have not been identified. The control module is configured to train a machine learning system or mathematical model with a first training dataset to reduce a global error measured across all the training dataset's domain to obtain a trained machine learning system. In some embodiments, the first training dataset includes a collection of images containing a plurality of images wherein the images have characteristics which have been properly assigned semantic descriptions or labels. The control module is further configured to generate a second training dataset based on at least one target image, and to retrain the machine learning system with the second training dataset.

In some embodiments, the control module is further configured to generate the second training dataset by selecting images from the first training dataset that are similar to the target images, by selecting portions of or full target images that were predicted by the machine learning system (or mathematical model, or global domain mathematical model) with high confidence (i.e.: with a level of confidence equal to or above a predetermined threshold), and/or by selecting both, i.e. images from the first training dataset that are similar to the target image and portions of or full target images that were predicted by the machine learning system with high confidence. The second training dataset may further or alternatively include manually annotated full target images or portions of target images classified by the machine learning system with low confidence (i.e.: with a level of confidence below the predetermined threshold) and/or manually annotated full target images or portions of target images that were not similar to the original training set.

To select images from the first training dataset that are similar to the target images, the control module is further configured to generate an image feature descriptor vector for each pixel or set of pixels of the target image and the images from the first training dataset and computing the distance of image feature descriptor vectors, and selecting only those pixels/sets of pixels from the images of the first training dataset that are close in distance to the pixels/sets of pixels of the target images. In some embodiments, the image feature descriptor vectors can comprise, totally or partially, features derived from a machine learning model. In other examples, the image feature descriptor vectors can comprise, totally or partially, features derived from intrinsic image characteristics such as, but not limited to, histograms, frequency analysis, and color composition.

Various examples are described herein to aid in illustration, although those examples are not meant to be taken in a limiting sense.

### Examples of Methods to Identify Aerial or Satellite Images

The process to gather information from aerial or satellite images to obtain target datasets with corresponding ground truth is typically slow and very costly. It can even be prohibitive to survey all areas of the globe (the Earth) with the necessary recurrence in order to obtain information which allows to distinguish and identify elements on the surface of the Earth within a reasonable amount of time. Due to the great economic effort needed to generate the necessary ground truth, one example which shows the advantages of the methods described herein, is the training of mathematical models using machine learning techniques and specifically generated training datasets to learn segmentation of aerial or satellite images, and transfer the knowledge learned from images captured in a given area or region to generate predictions in any part of the globe and at any time of the day and year.

The described methods also allow to specialize in a particular domain, which could be geographic, seasonal, or similar, to automatically segment images of newly seen areas or regions of the Earth, without being restricted to determined parts of the Earth or seasons because there are insufficient images with ground truth. In one example, the method includes machine learning techniques to train mathematical models to learn segmentation of aerial or satellite images captured from an aerial vehicle. An aerial vehicle can be for example an aircraft, a spacecraft, a drone, a plane, a satellite which may be a low-earth orbit satellite, an unmanned aerial vehicle (UAV) or a similar vehicle flying over the Earth.

In this case, the target images (target datasets) include one or more aerial or satellite images captured from the aerial vehicle, and the source images (corresponding to a first training dataset) include a collection of images containing a plurality of aerial or satellite images with corresponding ground truth. The first training dataset has to be reliable and trustworthy, and may be machine-generated, human-generated, or a combination of these. Generally, models are trained with source images from the area where ground-truth is available that resemble and preserve the sampling distribution of the target images. Other examples of target and source images may also be used in the present disclosure, such as medical images, industrial images, security camera images, or other type of images, since the methods described herein include the processing of fixed or volatile images captured from imaging devices either partially or completely on the Earth or partially or completely on-board an aerial vehicle.

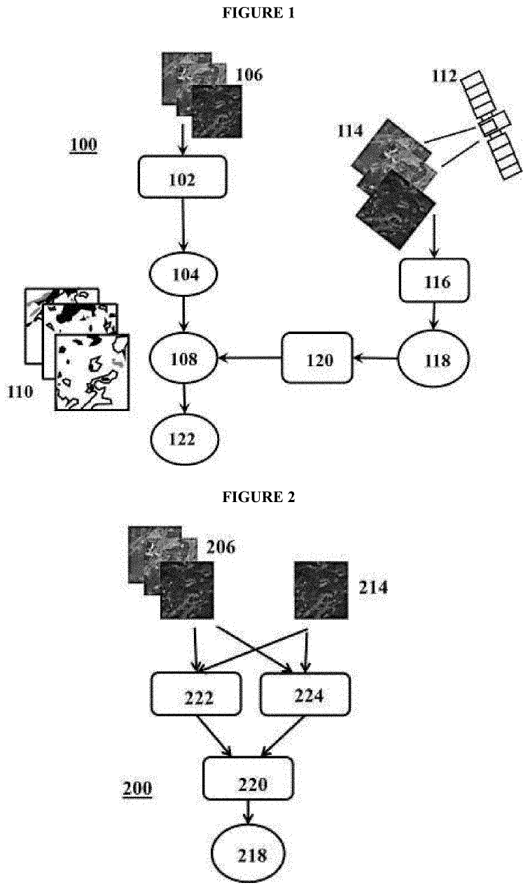

FIG. 1 shows a diagram of an example method 100 to generate a segmentation, such as a semantic segmentation of satellite images based on land use classes (from land-use classification systems) in accordance with an exemplary embodiment. The method includes training 102 a mathematical model 104 using all the samples from a given original training set 106 (first training set) to obtain a global domain mathematical model 108 that learns semantic segmentation of satellite images 110 based on land use classes. Preferably, the original training set 106 comprises labeled satellite images. In this example the model is trained to automatically predict discrete values, i.e. image content labels. The image content (class) labels which can be assigned to both target and training images include, but are not limited to, water bodies (rivers, lakes, dams), forest, bare land, waste land, buildings, roads, crop types and crop growth, soil composition, mines, oil and gas infrastructures, and/or different sub-classes or states of those such as different soil types, different crops, or different building types or functions. Once the mathematical model 104 is trained 102 to learn semantic segmentation of satellite images 110, the method 100 further includes capturing 112 one or more satellite images 114 without image content labels from an area or region of interest. Based on the one or more satellite images 114 the method 100 further includes generating 116 a training set 118 (second training set), and re-training 120 the global domain mathematical model 108 to obtain a predictive mathematical model 122, using the generated training set 118. In some examples, the mathematical model may be trained to predict a continuous quantity output for a dataset (regression), instead of being trained to predict a discrete class label output (classification). This is useful when the model is used for instance to determine different growing states of crops.

FIGS. 2, 4 and 5 show diagrams of exemplary methods to generate training sets to retrain a mathematical model to optimize the machine learning algorithm in order to adjust the output of the model so that the model can use knowledge from previous labeled satellite images and can predict with high accuracy the elements of the newly captured satellite image by semantic segmentation, even though the images from the original training set are from a different region of the Earth or taken at a different season or time of the day.

FIG. 2 shows the method 200 to generate a training set 218 by selecting those labeled satellite images 206 (first training set) that are closest to a satellite images 214 (target dataset) captured by a satellite. In some cases, only one labeled satellite image 206 is selected, however in other situations, two or more labeled satellite images 206 are selected for being similar to the satellite images 214, which can also comprise only one satellite image. The method 200 generates the training set 218 (second training set) by measuring the similarity between images, comparing the features vectors 220 and selecting those which are below a distance or distance threshold, i.e. above a similarity level. Machine learning based methods 222, such as artificial neural networks, deep learning techniques, or other similar methods, can be used as a feature extractor which generates a feature vector for each image from the set of labeled satellite images 206 and satellite image 214. In other examples, general image descriptor vector generators 224 can be used as a feature extractor which generates a feature vector for each image from the set of labeled satellite images 206 and satellite image 214. In still other examples, the combination of both machine learning based methods 222 and general image descriptor vector generators 224 can be used as feature extractors. The similarity between two images is computed by combining the distance between the two feature vectors and the distance from a general image descriptor vector composed of average image color, the color histogram, the histogram of oriented gradients and slopes. And the similar images that lie within a given neighborhood of the domain of the satellite images 214 are included in the training set 218. The aforementioned neighborhood is computed by looking at the distance between the feature vector of each satellite image 214 and the corresponding vector for each of the labeled satellite image 206 and selecting those labeled satellite images for which the distance is below a specific distance threshold. Thus, this neighborhood will be defined by a certain number of labeled satellite images 218 which are the closest to the satellite image 214 to be classified.

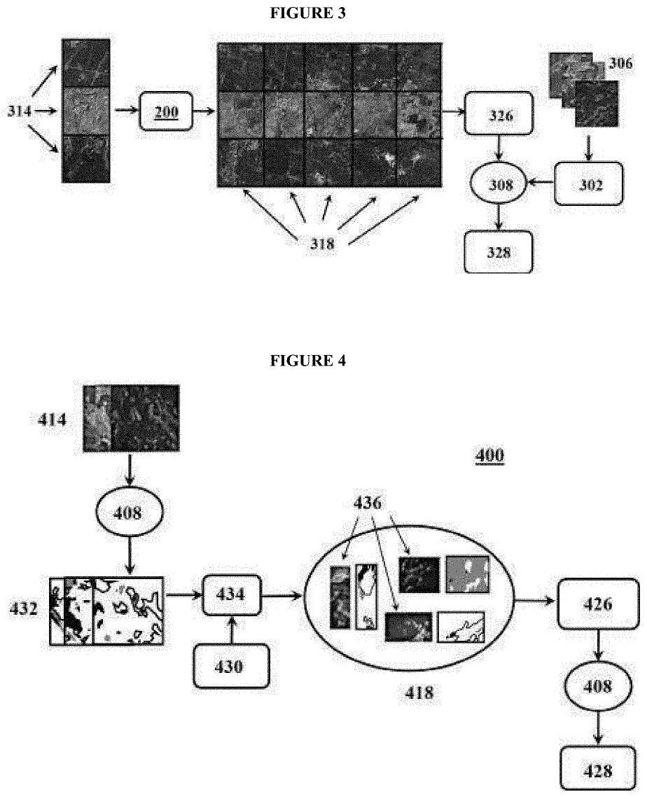

FIG. 3 illustrates three satellite images 314 (target images) captured by a low-orbit satellite and its five closest labeled satellite images comprising the training set 318 (second training dataset) generated by the method 200 of FIG. 2. Once a preselected number (k) of closest labeled satellite images have been identified, they are used to retrain 326 the model 308, which had already been globally trained 302 with all the labeled satellite images from the original training set 306 (first training dataset). In this manner, the process results in a function 328 which is locally adjusted to the new domain.

FIG. 4 shows a diagram of another exemplary method to generate a training set 418 (second training dataset) to retrain 426 the global mathematical model 408 to obtain a predictive mathematical model 428. The method 400 to generate a training set 418 includes setting a threshold value 430, then computing predictions 432 of the global mathematical model 408 for the one or more satellite images 414, and select 434 chunks 436 of one or more satellite images 414 whose predictions 432 in all the pixels of the selected portions of the image have a higher score than the given threshold, that is, with high confidence, or in other words, with a level of confidence above (or equal to, depending on how the determination is made) the given threshold. The chunks 436 of one or more satellite images 414 predicted by the global mathematical model 408 with high confidence comprise the training set 418. In some cases, the method 400 uses a semi-supervised method to select chunks or the portions of images that have been labeled by the mathematical model 408 with high confidence. One example of how to set a threshold value involves first computing predictions of the global mathematical model for the labeled satellite images, wherein the global mathematical model was originally trained with all the labeled satellite images. Based on the predictions from the global mathematical model on the labeled satellite images, determine a value per class in which the predictions in all the pixels have a preselected score, meaning they have a preselected level of accuracy.

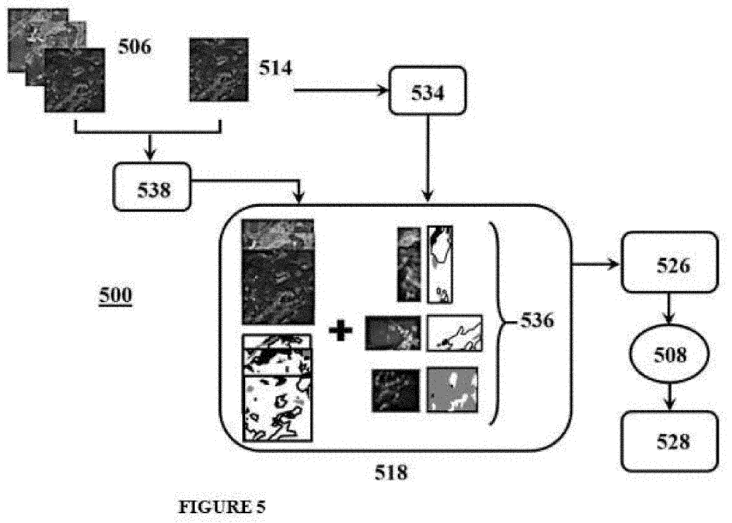

FIG. 5 shows the method 500 to generate a training set 518 (second training dataset) which includes computing 538 for each unlabeled captured image 514 (target dataset) the closest instances from the original training set 506 (first training dataset), and selecting 534 images and/or regions or chunks 536 from unlabeled captured images 514 which have been predicted with high confidence (confidence level above a threshold). In some instances, the confidence level may be expressed using probabilities, and the threshold may be for example 80%, 90% or 99%, or any other value. This set of full and partial images comprises the training set 518 employed to retrain 526 the global mathematical model 508 to obtain a predictive mathematical model 528 specialized to perform better within the neighborhood of the target dataset. The training images closest to the target images can be selected for example with a non-supervised machine learning method that measures the similarity between images, whereas the images and/or regions or chunks from the target images can be predicted using the previously trained global model.

In general, the method provides an iterative local function approximation technique that combines redefinition of a global function adjusting it around the target domain and data augmentation using confidently predicted parts of target datasets as new train data. The method provides a significant improvement in the classifier performance to automatically monitor land use. In this manner, the process results in a function which is locally adjusted to the new domain.

Additionally, the model can be trained to automatically predict continuous values from images including, but not limited to the level of water bodies (rivers, lakes, dams), the stage of crop growth, the amount of waste in a waste dump, and similar tasks. In general, the method can also be used in regression analysis using machine learning algorithms.

### Examples of a System to Process Aerial or Satellite Images

One example of a system as described above, includes an aerial or satellite-based system comprising an imaging device and a control module. The aerial or satellite-based system may be all or partially on-board an aerial vehicle, such as, but not limited to, an aircraft, a spacecraft, a drone, a plane, or a satellite which may be a low-earth orbit satellite. In some embodiments, some or all of the components of the system may be ground-based or on-board a separate aerial vehicle, with such ground-based or separate aerial vehicle in communication with a portion of the system. For example, the optics systems (e.g., the lens and the sensor array, among other things) of the imaging device may be on-board a satellite whereas other components, such as any suitable computing device or system of the imaging device, may be ground-based.

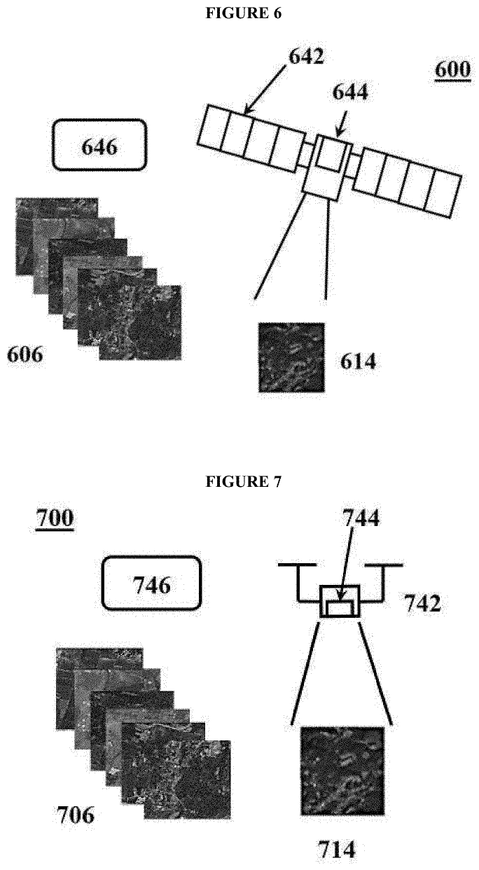

A satellite-based system is shown in FIG. 6. The system 600 can be used to implement the methods described in FIGS. 1 to 5, and it includes a satellite 642 having the optics/capturing system 644 onboard the satellite 642 and a control module 646 which may be all or partially onboard the satellite 642 or ground-based. The optics/capturing system 644 acquires at least one satellite image 614 (target image) from the surface of the Earth, and the control module 646 uses the satellite image 614 without image content labels and a plurality of satellite images 606 (first training dataset) having image content labels, to generate a training set (second training dataset) and train a machine learning algorithm to automatically identify and classify the type of land cover contained in the image and assigned one or more image content labels to the satellite image 614.

In some instances, the system may comprise one or more aerial vehicles, so that the system directs at least one aerial vehicle equipped with an imaging device to capture aerial or satellite images having unknown image content labels at selected locations.

The control module 646 is further configured to generate those training datasets, such as, but not limited to, the training sets 118, 218, 318, 418, 518, which are more relevant to the target domain using for example artificial neural networks, including deep learning techniques, non-supervised machine learning methods, semi-supervised machine learning methods, or convolutional neural networks. The control module 646 is further configured to retrain the machine learning algorithms with the generated training sets based on the target datasets to obtain a new predictive model. In some cases, those training datasets which are more relevant to the target domain include, but are not limited to, source images that are close to the unlabeled target dataset from the target domain, and chunks of one or more target images from the unlabeled target dataset from the target domain that were labeled by the mathematical model with high confidence. In some cases, the source images that are close to the unlabeled target dataset are selected by using a non-supervised machine learning method, and the chunks of one or more target images are selected by using other machine learning methods.

The new predictive model obtained based on the generated training set is capable of assigning one or more image content labels of the images captured by the aerial vehicle from an area or region of interest and predict with high accuracy the elements of the newly captured satellite image, even though the images from the original training set are from a different region of the earth or taken at a different season or time of the day.

In some cases, the generated training sets can include of a) one or more source images having identified image feature descriptor vectors similar to the image feature descriptor vectors of the target images without image content labels, b) one or more full target images and/or one or more portions of target images without image content labels which have been assigned a label by the mathematical model with a predetermined level of confidence, or c) both set of images of a) and b). The predetermined level of confidence can be defined in relation to a level of accuracy (whether the level of accuracy is of a predetermined value or more) of the identification, classification or labeling process. In some instances, the generated training sets further include full target images or portions of target images that were assigned a label manually because their output values were predicted by the global mathematical model with low confidence or because the image feature descriptor vectors of the target images were above certain distance threshold from the image feature descriptor vectors of the original training set. In some instances, the mathematical model assigns a continuous value (e.g. continuous label) instead of a discrete value (label), such as in regression or probabilistic regression predictive modeling, and the generated training sets may include a) one or more source images having a predicted continuous value similar to the continuous value of the target images, b) one or more full target images and/or one or more portions of target images which have been assigned a continuous value (i.e. continuous label) by the mathematical model with a predetermined level of confidence, or c) both set of images of a) and b). For example, a global domain mathematical model may have been trained with a first training dataset containing images providing the extent of wheat growth within the images. A satellite may take satellite images of wheat fields without determining the extent of wheat growth (target dataset). The generated training set may include a) one or more images from the first training dataset having an extension of wheat growth similar to the extension of wheat growth of the satellite images, b) one or more full satellite images and/or one or more portions of satellite images with an extension of wheat growth predicted by the global domain mathematical model with a level of confidence of above 90%, or c) both set of images of a) and b). The generated training set may also include full target images or portions of target images that were assigned a continuous value manually because their output values were predicted by the global mathematical model with low confidence.

FIG. 7 illustrates a system 700 including a drone 742 or UAV having a camera 744 onboard the drone 742 and a control module 746 which may be part onboard the drone 742 and part ground-based. The camera 744 acquires at least one aerial image 714 from the surface of the Earth, and the control module 746 uses the aerial image 714 and a plurality of aerial images 706 having image content labels, to generate a training set and train a machine learning algorithm as described with relation to the previous figures, to automatically extract data from the aerial image 714 and determine the level of water at both sides of the dam, which has been captured by the aerial image 714. The control module 746 does a regression analysis using the trained machine learning algorithm and provides the level of water at the dam at a given time.

### CONCLUSION

Although the disclosure uses language that is specific to structural features and/or methodological acts, the invention is not limited to the specific features or acts described. Rather, the specific features and acts are disclosed as illustrative forms of implementing the invention.

1-31. (canceled)

32. A method to automatically transfer knowledge in machine learning algorithms, the method comprising:
obtaining at least one target dataset, wherein the at least one target dataset comprises at least one image;
generating a second training dataset based on the at least one image; and
retraining a global domain mathematical model with the second training dataset;
wherein the global domain mathematical model is a mathematical model trained, by executing a machine learning algorithm, with images of a first training dataset to reduce a global error measured across the first training dataset.

33. The method according to claim 32, wherein the second training dataset comprises similar images of the first training dataset that are similar to the at least one image of the at least one target dataset; wherein generating the second training dataset comprises selecting the similar images:
using image feature descriptor vectors totally or partially derived from a pre-trained machine learning model; or
by measuring a similarity between pixel level or image level descriptors of the images of the first training dataset and the at least one image of the at least one target dataset.

34. The method according to claim 33, further comprising:
generating an image feature descriptor vector for each pixel or set of pixels of each image of the at least one target dataset to obtain at least some of the image feature descriptor vectors;
generating an image feature descriptor vector for each pixel or set of pixels of each image of the first training dataset to obtain at least some of the image feature descriptor vectors;
computing a distance between the image feature descriptor vectors; and
selecting pixels or sets of pixels of the images of the first training dataset that have a distance lower than a threshold distance to the pixels or sets of pixels of the at least one image of the at least one target dataset.

35. The method according to claim 34, wherein an individual image feature descriptor vector of the image feature descriptor vectors is the result of combining different image feature descriptor vectors selected from a group comprising histograms of gradient orientations (HOG), red-green-blue (RGB) color histograms, texture histograms, response to wavelets filters, artificial neural networks, and deep neural network features extracted from a pre-trained model; or wherein the image feature descriptor vectors, the way the image feature descriptor vectors are combined, and a function that measures the distance between the image feature descriptor vectors, are selected depending on one or more image transformation invariances, wherein the one or more image transformation invariances include any combination of translations, rotations, scaling, shear, image blur, or image brightness and contrast changes.

36. The method according to claim 32, wherein the second training dataset comprises portions or full images from the at least one target dataset that were predicted by the global domain mathematical model with a predetermined level of confidence.

37. The method according to claim 36, wherein the predetermined level of confidence is defined in relation to a level of accuracy in a prediction of an identification, classification or labeling process of the at least one image of the at least one target dataset.

38. The method according to claim 36, wherein the portions or full images are obtained by using a semi-supervised machine learning method and selected using their pixel-wise confidence levels, wherein a threshold value per class is predetermined, and wherein the prediction from the global domain mathematical model in the pixels of the portions or full images is above the predetermined threshold.

39. The method according to claim 32, wherein the second training dataset comprises:
images from the first training dataset that are similar to the at least one image of the at least one target dataset, and
portions or full images from the at least one target dataset that were predicted by the global domain mathematical model with a level of confidence above a predetermined threshold.

40. The method according to claim 32, wherein the second training dataset further comprises manually labeled full images or portions of images of the at least one target dataset that were:
classified by the global domain mathematical model with a level of confidence below a predetermined threshold; or
not similar to the first training dataset; or
classified by the global domain mathematical model with the level of confidence below the predetermined threshold and not similar to the first training dataset.

41. The method according to claim 32, wherein the at least one target dataset is captured by an imaging device all or partially onboard an aerial vehicle, wherein the aerial vehicle is selected from a group comprising a satellite, a spacecraft, an aircraft, a plane, an unmanned aerial vehicle, UAV, and a drone.

42. The method according to claim 32, wherein the global domain mathematical model is trained and retrained to learn segmentation of images of the at least one target dataset comprising aerial or satellite images based on land use classes; or wherein the global domain mathematical model is trained and retrained to automatically predict continuous or discrete values from imagery content.

43. The method according to claim 42, wherein the global domain mathematical model segments image contents with image content labels selected from a group comprising water bodies, rivers, lakes, dams, forests, bare lands, waste dumps, buildings, roads, crop types, crop growth, soil composition, mines, oil and gas infrastructure.

44. The method according to claim 32, wherein training and retraining the global domain mathematical model, and generating the second training dataset are performed using at least one of artificial neural networks, deep learning techniques, non-supervised machine learning methods, semi-supervised machine learning methods, or convolutional neural networks.

45. The method according to claim 37, further comprising:
selecting, as selected pixels or sets of pixels, pixels or sets of pixels from the at least one image of the at least one target dataset that have a distance value that is equal to or larger than a threshold distance value to pixels or sets of pixels of the images of the first training dataset;
manually annotating a label or assigning a value to the selected pixels or sets of pixels to obtain one or more first labeled images; and
adding the one or more first labeled images of the at least one target dataset to the second training dataset; or
selecting, as one or more selected target images, portions or full images from the at least one target dataset that were predicted by the global domain mathematical model with a predetermined level of confidence below a predetermined threshold;
manually annotating a label or assigning a value to pixels or sets of pixels of the one or more selected target images to obtain one or more second labeled images; and
adding the one or more second labeled images to the second training dataset.

46. A system comprising:
an imaging device configured to capture at least one target image;
a global domain mathematical model trained with a first training dataset to reduce a global error measured across the first training dataset; and
a control module configured to
obtain at least one target dataset, wherein the at least one target dataset comprises the at least one target image;
generate a second training dataset based on the at least one target image; and
retrain the global domain mathematical model with the second training dataset;
wherein training the global domain mathematical model comprises executing a machine learning algorithm

47. The system according to claim 46, wherein the first training dataset comprises a collection of images containing a plurality of images having characteristics which have been assigned semantic labels.

48. The system according to claim 46, wherein the control module is further configured to:
generate the second training dataset comprising images or portions of images from the first training dataset that are similar to the at least one target image; or
generate the second training dataset comprising portions or full target images that were predicted by the global domain mathematical model with a predetermined level of confidence.

49. The system according to claim 46, wherein the control module is further configured to generate the second training dataset comprising:
images or portions of images from the first training dataset that are similar to the at least one target image, and
portions or full target images that were predicted by the global domain mathematical model with a level of confidence above a predetermined threshold.

50. The system according to claim 46, wherein the control module is further configured to generate the second training dataset comprising manually annotated full target images or portions of target images:
classified by the global domain mathematical model with a level of confidence below a predetermined threshold; or
that were not similar to the first training dataset.

51. The system according to claim 46, wherein the system is all or partially on-board an aerial vehicle, or a ground-based or separate aerial vehicle, with such ground-based or separate aerial vehicle in communication with a portion of the system; and the aerial vehicle is selected from a group comprising an aircraft, a spacecraft, a drone, a plane, an unmanned aerial vehicle, UAV, and a satellite.
